(19) United States
(12) Patent Application Publication
(10) Pub. No.: US 2006/0077183 A1
(43) Pub. Date: Apr. 13, 2006

(54) Methods and systems for converting touchscreen events into application formatted data

(76) Inventor: Peter C. Studt, San Ramon, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 10/961,260

(22) Filed: Oct. 8, 2004

(51) Int. Cl. G09G 5/00

(52) U.S. Cl. 345/173

(57) ABSTRACT

A method is provided for converting touch screen events into application-specific formatted data. The method includes detecting a touch screen event and identifying an active event zone associated with the touch screen, where the active event zone contains the touch screen event. The method further includes outputting application-specific formatted data based on the active event zone. In accordance with an embodiment, a touch screen system is provided comprising a display screen presenting application-specific information and an application interacting with the display screen to present the application-specific information. The application defines application formatted data sets utilized by the application in connection with the application-specific information. A sensor unit proximate to the touch screen senses a touch screen event that occurs at the touch screen. An event table contains event zones associated with the application-specific information presented on the display screen. A touch screen control module identifies, from the event zones within the event table, an active event zone containing the touch screen event. The touch screen control module outputs, to the application, an application formatted data set based on the active event zone.

### BACKGROUND OF THE INVENTION

The present invention generally relates to methods and systems for converting touch screen events into application formatted data.

Today, a wide variety of conventional touch screen systems are used in various applications. Examples of applications include retail sales, restaurants, point of sale terminals, kiosks, ATM machines, medical systems, e-mail packages and the like. Touch screen systems typically include a display joined with a touch or proximity sensor mechanism. The sensor mechanism detects a user's finger or hand, or an instrument when located proximate to the display. The display is controlled to present application-specific information to the user including, among other things, graphics, text, video and audio. Examples of application-specific information include virtual telephone pads, calculators, cash-registers, key boards, electronic documents and receipts, and windows. The application-specific graphics may represent toolbars, pop-up menus, scrollbars, text entry windows, icons, electronic writing or signature boxes and the like.

The sensor mechanism detects the presence of a finger or instrument and generates a touch screen event in response thereto. The touch screen event may represent a touch event, a release event, a streaming or drag event and the like. The touch screen event includes data or signals representative of the event type and identifying the position (or positions) at which the event occurred.

The display is controlled by the application running on a system computer. The application controls the display to present the application-specific information to the user. The display and touch screen function as a user interface, through which the user inputs data to the application. The user -entered data may represent dollar amounts, product information, patient/customer information, medical information, patient vitals, test results, internet addresses, web-site content, e-mail-related content and the like. The user may input the data by selecting a key, menu item or button, writing in a box, pressing virtual alphanumeric keys and the like.

However, in conventional touch screen systems, the application that drives the display also directly communicates with the sensor mechanism of the touch screen. When writing/modifying an application, the programmer defines the information to be displayed. In addition, due to the direct interaction between the application and the touch screen, the programmer is also required to incorporate, into the application, instructions defining the interface between the application and the touch screen. The interface instructions specify the characteristics of the touch screen events that may be entered at the touch screen by the user.

Generally, touch screens produce “raw” touch screen data, namely the event detected and the event position. The programmer is required to incorporate into the application functionality to a) validate and distinguish touch screen events, b) associate each event with the displayed information and c) act accordingly to control the related software application. Hence, the programmer needs a detailed understanding of the low-level format and operation of the touch screen sensor mechanism and the characteristics and content of the touch screen event. Further, numerous types of touch screens exist, each of which may utilize a different format for the touch screen events. Consequently, programmers are required to individualize each application to the corresponding type of touch screen.

A need exists for methods and systems that provide a generalized interface between application software and touch screen sensing mechanisms.

### BRIEF SUMMARY OF THE INVENTION

A method is provided for converting touch screen events into application-specific formatted data. The method includes detecting a touch screen event and identifying an active event zone associated with the touch screen, where the active event zone contains the touch screen event. The method further includes outputting application-specific formatted data based on the active event zone.

Optionally, the method may compare the touch screen event to a table of event zones and generate a list of potential event zones, from which the active event zone is then identified. Once the list of potential event zones is generated, the active event zone may be identified based on a priority ranking. When the touch screen event occurs inside of overlapping event zones, one event zone is identified as the active event zone based upon the priority ranking of the event zones. The touch screen event may comprise at least one of a touch event, a release event, or a drag event and comprise event position coordinates relative to a touch screen coordinate system. Each event zone may be assigned to at least one mode, such as a scroll mode, an electronic writing mode, a mouse functionality mode, a button mode and the like.

### BRIEF DESCRIPTION OF THE DRAWINGS

FIG. 1 illustrates a touch₌screen presented in connection with a touch screen application in accordance with an embodiment of the present invention.

FIG. 2 illustrates a block diagram of a touch screen system formed in accordance with an embodiment of the present invention.

FIGS. 3A and 3B illustrate a logic flow diagram performed to convert touch screen events into application-specific formatted data in accordance with an embodiment of the present invention.

### DETAILED DESCRIPTION OF THE INVENTION

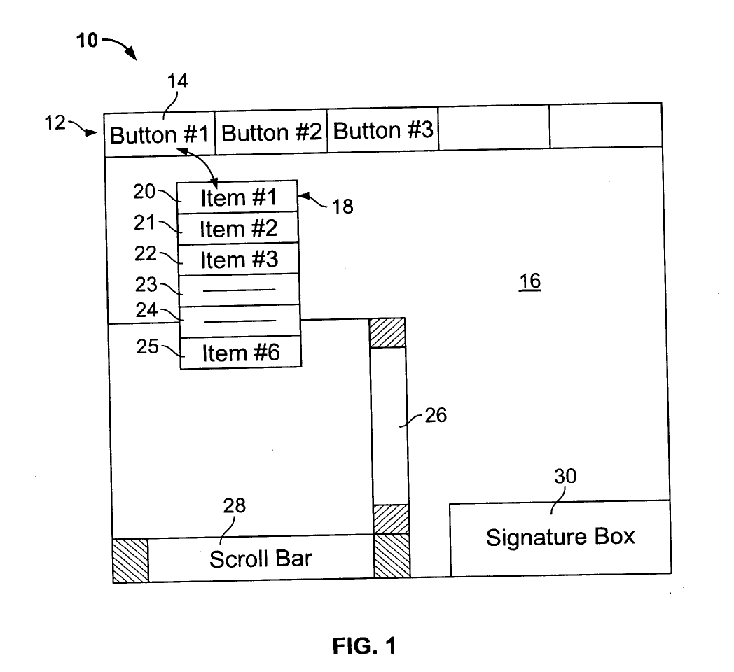

FIG. 1 illustrates a touch screen 10 presented in connection with a touch screen-based application. The touch screen 10 divides the available touch area into different touch or event zones. The application software may use different parts of the touch area in connection with different functions. Each event zone may be associated with different event response characteristics or modes.

The term “touch screen” is used throughout in its broadest context. For example, the touch screen may represent an apparatus or device that presents graphical or image information, such as a liquid crystal display (LCD) with an integral or separable touch screen. The LCD may be touch sensitive. Alternatively, the touch screen may represent a physical device, such a piece of glass, capable of sensing touch, where the physical device does not necessarily directly present graphical or image information. Instead, the touch sensitive physical device may be placed in front of a separate display screen. The term “touch screen” may refer to the touch sensitive physical device alone, as well as, more generally, to the display screen in combination with the touch sensitive physical device.

The information presented by or in connection with, touch screen 10 includes a toolbar 12 comprising a plurality of button zones 14 (e.g., Button #1, Button #2, Button #3, etc). A background zone 16 is denoted in the mid portion of the touch screen 10 and has a pop-up menu 18 superimposed thereon. The pop-up menu 18 comprises a series of menu item zones 20-25, each of which is associated with an item function (e.g., Item #1, Item #2, etc). By way of example only, the menu 18 may be generated when Button #1 is selected in button zone 14. A vertical scroll bar is presented in a vertical scroll zone 26 to the user, while a horizontal scroll bar is presented in a horizontal scroll zone 28 to the user. A signature box is presented in a writing zone 30. The zones 14-30 are associated with different event modes or characteristics as explained below in more detail.

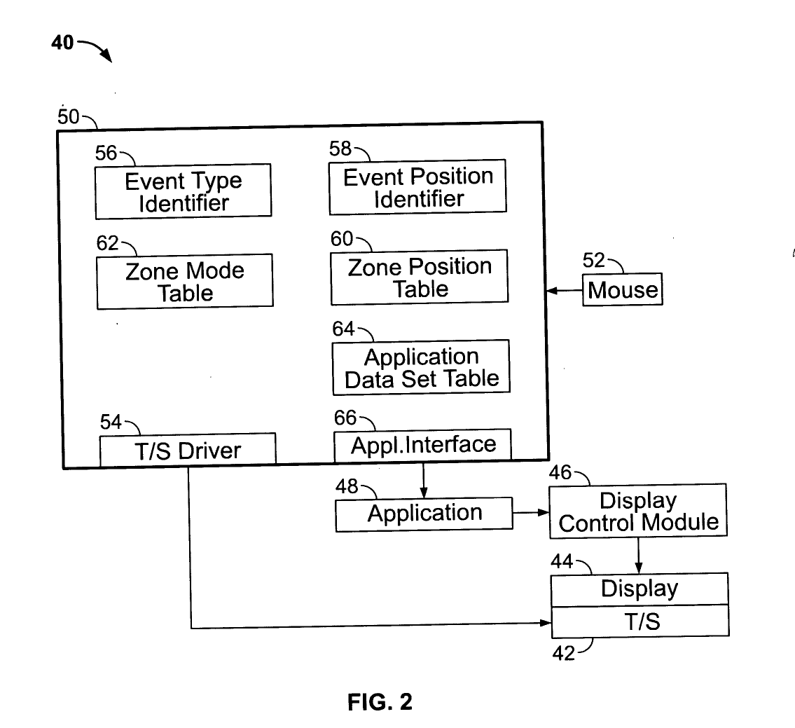

FIG. 2 illustrates a block diagram of a touch screen system 40 that includes a touch screen 42 joined with a display 44. The display 44 is controlled by a display control module 46 to present graphical or image information in connection with the touch screen 10 such as illustrated in FIG. 1. The display control module 46 communicates with application 48 which determines and controls, among other things, the order of operations, layout, functionality and the like offered to the user. The application 48 communicates with a touch screen control module 50 which in turn drives the touch screen 42 and receives touch screen events from the touch screen 42. Optionally, a computer mouse 52 may be connected to the touch screen control module 50 and/or application 48. The application 48 may be implemented on a general purpose computer and the like.

The touch screen control module 50 includes a touch screen interface or driver 54 which transmits drive signals to the sensors within the touch screen 42. The touch screen control module 50 also includes an event type identifier module 56 and an event position identifier module 58 that process touch screen events received from the touch screen 42. The event type identifier module 56 identifies the event type, while the event position identifier module 58 identifies event position. Examples of event types include touch events, release events and drag or streaming events. The event position may be defined based upon the coordinate system of the touch screen 42 such as by a pixel location, a row and column designator or an X-Y coordinate combination.

The touch screen control module 50 further includes a zone position table 60, a zone mode table 62, an application data set table 64 and an application interface 66.

The zone position table 60 contains a list of event zone records. Each event zone record is uniquely associated with an event zone. The list of event zone records in the zone position table 60 may contain all event zones utilized in connection with the touch screen 10 presented on the display 44. Alternatively, the zone position table 60 may store a complete list of event zone records associated with a plurality of touch screens 10 to be displayed on display 44 throughout operation of application 48. In the latter example, each event zone record would also include an “operational” field denoting event zones that are presently utilized in connection with a current touch screen 10.

Each event zone record may include, among other things, an event zone ID, coordinates defining the boundaries of the associated event zone, such as the diagonal corners of the event zone (e.g., Xₙ,Yₙ and xₙ, yₙ), the size of the event zone, the shape of the event zone, an overlap flag Fₒᵥₑᵣₗₐₚ, a preference ranking Pᵣₐₙₖ and the like. Event zones may be rectangular, square, circular, elliptical, triangular, and any other bounded shape. The overlap flag Fₒᵥₑᵣₗₐₚ is utilized to indicate whether the event zone overlaps another event zone (e.g., pop-up windows). The preference or priority ranking Pᵣₐₙₖ may be used to determine which event zone to activate when a touch screen event occurs within two or more overlapping event zones. An example may be when a pop-up menu overlaps another graphic, such as an icon, tool bar button and the like. The menu item zones in the pop-up window may be provided a higher priority or preference ranking than the event zone associated with the underlying graphic.

The zone mode table 62 stores zone mode records containing an event zone ID and one or more event mode flags F_{mode#N}. The event zone ID in the zone mode table 62 corresponds to the event zone ID in the zone position table 60 to afford a cross reference therebetween. The event mode flag F_{modeN} is used to correlate expected event types and/or sequences of events with application-specific responses which are output to the application 48 in the form of an application formatted data set. By way of example only, event modes may include F_{mode1}=“Touch Response in Event Zone”, F_{mode2}=“No Touch Response in Event Zone”, F_{mode3}=“Click on Touch”, F_{mode4}=“Click on Release”, F_{mode5}=“Drag on Touch”, F_{mode6}=“Double Click Left Button”, F_{mode6}=“Right Click Button” and the like.

In the above example, event mode F_{mode1} indicates that, when a touch event is detected, the touch screen control module 50 should immediately output a touch response from the application interface 66 to the application 48. Event mode F_{mode2} indicates that, when a touch event is detected, the touch screen control module 50 should not provide any output, but instead should ignore the touch event. Event mode F_{mode3} indicates that, when a touch event is detected, the touch screen control module 50 should immediately output a command corresponding to the click of the left button on a computer mouse. Event mode F_{mode4} indicates that touch screen control module 50 should output a command corresponding to the click of the left button on a computer mouse only after detecting both a valid touch event and a valid release event. Event modes F_{mode5} and F_{mode5} indicate that touch screen control module 50 should output commands corresponding to the double click of the left button and a single click of the right button, respectively, on a computer mouse after detecting a corresponding valid series of touch and release events within the associated event zone.

The application data set table 64 stores data sets, each data set of which is formatted to the specific application. Each application formatted data set is defined by the application 48 and represents input values acceptable to the application 48. By way of example, an application formatted data set may present a command associated with a single left button mouse click, a double left button mouse click, a right button mouse click, an ASCII character, an ASCII string of characters, a keyboard function such as an enter, a control, or an alt function, a function associated with a calculator, a series of coordinates such as identifying a signature or any system functional command that may be initiated by a data sequence from an input device. Optionally, the application formatted data sets may redefine or redirect the buttons or virtual keyboard keys, such as to reorder the key layout of the keyboard.

During initialization, the application 48 may load the zone position table 60, zone mode table 62, and application data set table 64 through the application interface 66. Optionally, the application may dynamically alter the zone position table 60, zone mode table 62, and application data set table 64 in real time.

The application 48 and touch screen control module 50 may be implemented utilizing a single processor, parallel processors, separate dedicated processors and the like. The touch screen control module 50 may represent a separate entity from a host computer system running the application 48. Alternatively, the touch screen control module 50 may be implemented as part of the host computer system. Optionally, the functionality of the touch screen control module 50 and of the application 48 may be carried out in combination by host and separate computer systems, or as a distinct pair of separate and independent functional entities.

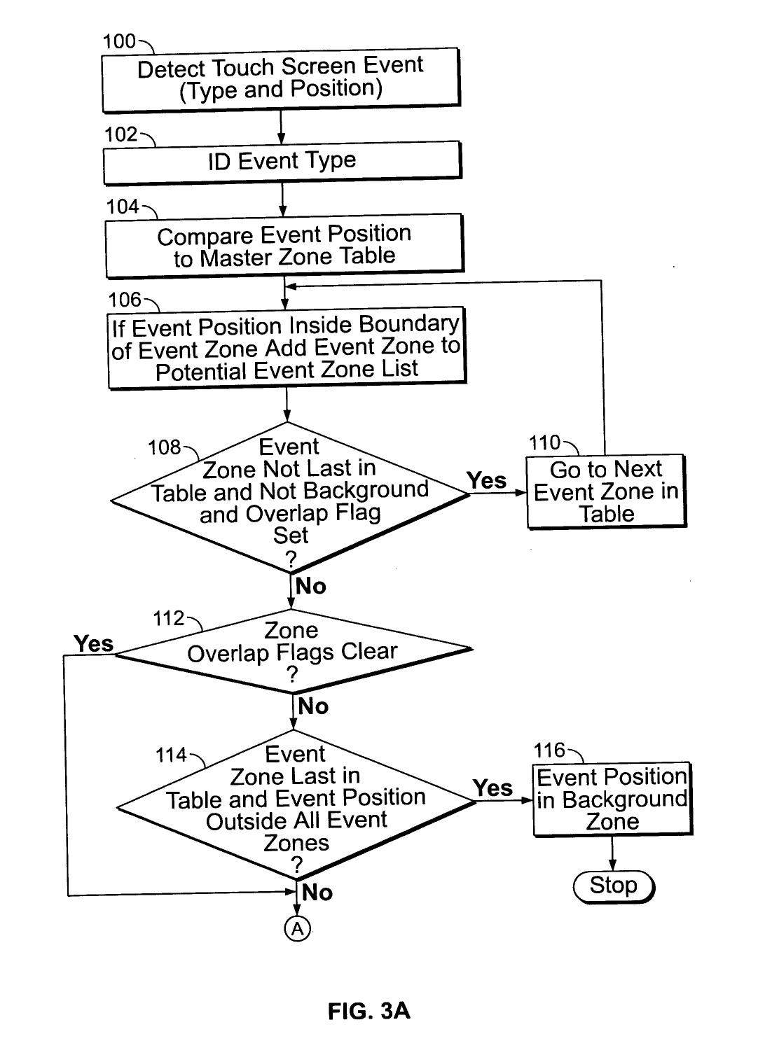

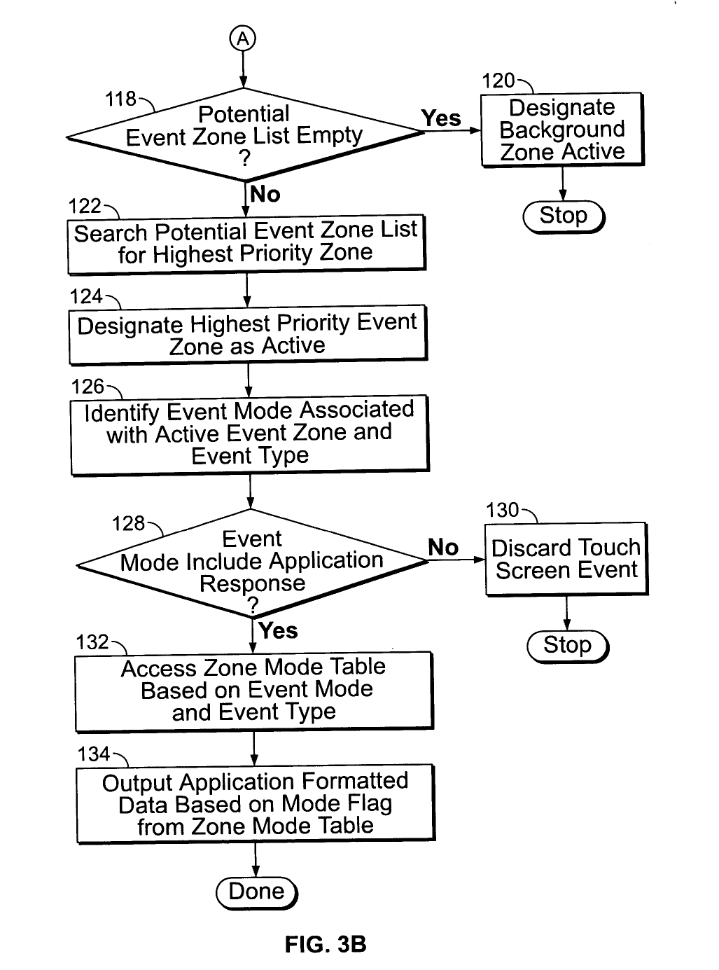

The operation of the touch screen control module 50 is explained below in more detail in connections with FIGS. 3A and 3B.

FIGS. 3A and 3B illustrate a logic flow diagram of the process carried out by the touch screen control module 50 to convert a touch screen event into an application formatted data set. At step 100, the touch screen 42 detects a touch screen event and provides an event type and an event position to the touch screen control module 50. The event type identifier module 56 identifies the event type at step 102. The event position identifier module 58 compares the event position to an event zone record in the zone position table 60, at step 104. The comparison at step 104 is performed by comparing the position of the touch screen event with the boundary coordinates of the currently selected event zone.

If a touch screen event position falls within the boundary of the event zone, at step 106 the event zone is added to a list of potential event zones. At step 108, it is determined, a) whether the event zone analyzed at step 106 is the last event zone in the zone position table 60, b) whether the event zone is a background zone and c) whether an overlap flag has been set in connection with the current event zone. The overlap flag is set when the current event zone overlaps another event zone on the display 44. If the decision at step 108 is yes, flow passes to step 110, at which processing moves to the next event zone record in the zone position table 60 (FIG. 2). Steps 106, 108 and 110 are repeated until each event zone record is considered or the event position is determined to reside in a background zone.

At step 112, it is determined whether the overlap flag is clear for the event zones on the potential event zone list. If yes, flow passes to step 118 in FIG. 3B. If not, flow passes to step 114, at which it is determined whether the event zone presently represents the last event zone in the zone position table 60. At step 114 it is also determined whether the event position falls outside of all event zones presently being utilized on the display 44. If the determination in step 114 is yes, flow passes to step 116, at which the event position is determined to fall within the background zone and processing stops. If, at step 114, the event position is determined to fall within at least one other event zone, flow passes to step 118 in FIG. 3B.

Turning to FIG. 3B, at step 118, it is determined whether the potential event zone list is empty. If yes, the background zone is designated active at step 120 and flow stops. Alternatively, if at step 118, the potential event zone list is not empty, flow passes to step 122, at which the potential event zone list is searched for the highest priority event zone. Each event zone record in the zone position table 60 is provided a preference or priority ranking which is used in step 122 to identify the highest priority event zone. At step 124, the highest priority event zone is designated at the active event zone. At step 126, the zone mode record in the zone mode table 62 of the active event zone is accessed to obtain the event mode associated with the active event zone. At step 128, it is determined whether the event mode includes an application response. When an application response exists, this indicates that the touch screen control module 50 should provide some type of data set to the application 48 (FIG. 2). When the event mode does not include an application response, flow passes to step 130 at which the touch screen event is discarded and processing stops. If at step 128, the event mode includes an application response, flow passes to step 132, at which the zone mode table 62 is accessed to obtain the mode flag based on the event mode and event type. At step 134, the index or mode flag from the zone mode table 62 (FIG. 2) is used to identify, within the application data set table 64, an application formatted data set that is then output to the application 48. Thereafter, processing ends and flow returns to step 100 to await detection of the next touch screen event.

Optionally, the application-based coordinate system may differ from the coordinate system of the touch screen 42. For example, the touch screen 42 may include a coordinate system having a first resolution (e.g., 4000×4000), while the application-based coordinate system has a lower resolution (e.g., 1024×1024). Alternatively, the touch screen 42 may operate based on a polar coordinate system, while the application-based coordinate system may be Cartesian coordinates (or vice verse). The touch screen control module 50 would perform a conversion between coordinate systems.

Optionally, the touch screen control module 50 may provide a “delayed drag” function such that, when a user drags a finger or instrument across the touch screen, the underlying graphical representation following the user's finger (e.g., the mouse or a line) would lag behind the user's finger. Alternatively, the touch screen control module 50 may provide an “extended touch” function proximate to the border of the touch screen such that, as the user's finger approaches the border of the touch screen, the event position information output to the application 48 is indexed closer to the border than the actual position of the user's finger. The extended touch function may be useful when an event zone is small and located close to the corner or side of the display 44, such as the maximize, minimize and close icons on a window.

While the invention has been described in terms of various specific embodiments, those skilled in the art will recognize that the invention can be practiced with modification within the spirit and scope of the claims.

What is claimed is:

1. A method for converting touch screen events to application formatted data, comprising:
detecting a touch screen event;
identifying an active event zone associated with the touch screen, the active event zone containing the touch screen event; and
outputting application formatted data based on the active event zone.

2. The method of claim 1, further comprising comparing the touch screen event to a table of event zones to determine at least one potential event zone.

3. The method of claim 1, further comprising generating a list of potential event zones, from which the active event zone is identified based on a priority ranking.

4. The method of claim 1, further comprising determining whether the touch screen event is inside overlapping first and second event zones or multiple overlapping zones.

5. The method of claim 1, further comprising identifying an event mode based on the active event zone and a type of the touch screen event.

6. The method of claim 1, further comprising accessing at least one zone attribute from a plurality of zone attributes based on the active event zone and touch screen event.

7. The method of claim 1, further comprising associating multiple zones with the touch screen.

8. The method of claim 1, further comprising assigning, to an event zone, at least one of a scroll mode, an electronic writing mode, a mouse functionality mode and a button mode.

9. The method of claim 1, wherein said touch screen event comprises at least one of a touch event, a release event, a drag event and a streaming event.

10. The method of claim 1, wherein said touch screen event comprises event position coordinates relative to a touch screen coordinate system.

11. The method of claim 1, further comprising a touch screen coordinate system and a different application coordinate system.

12. A touch screen system, comprising:
a touch screen presenting application-specific information;
an application interacting with said touch screen to present said application-specific information, said application defining application formatted data sets utilized by said application in connection with said application-specific information;
a sensor unit proximate to the touch screen sensing a touch screen event that occurs at said touch screen;
an event table containing event zones associated with said application-specific information presented on said touch screen;
a touch screen control module identifying, from said event zones within said event table, an active event zone containing said touch screen event, said touch screen control module outputting, to the application, an application formatted data set based on said active event zone.

13. The system of claim 12, wherein said touch screen control module compares said touch screen event to a table of event zones to determine a list of potential event zones. PCS: The touch screen control module may be independent or integral with the processor.

14. The system of claim 12, wherein said touch screen control module identifies said active event zone based on a priority ranking.

15. The system of claim 12, wherein said touch screen control module determines whether the touch screen event is inside overlapping first and second event zones or multiple overlapping zones.

16. The system of claim 12, wherein said touch screen control module identifies an event mode based on the active event zone and a type of the touch screen event.

17. The system of claim 12, wherein said touch screen control module accesses at least one zone mode from a plurality of zone mode records based on the active event zone and touch screen event.

18. The system of claim 12, wherein said touch screen control module associates multiple zones with the touch screen.

19. The system of claim 12, wherein said touch screen event comprises at least one of a touch event, a release event, a drag event and a streaming event.

20. A touch screen control module for converting touch screen events to application formatted data sets, comprising:
a touch screen interface configured to communicate with a touch screen, said touch screen interface receiving touch screen events, each touch screen event being associated with at least one of a touch event, a release event, a drag event and a streaming event, an application interface configured to communicate with a software application, said application defining event zones, event modes associated with said event zones and application formatted data sets associated with said event modes;
zone mode records associating event modes with said event zones; and
an event identifier designating one of said event zones as an active event zone based on said touch screen event, said application interface outputting to said application an application formatted data set associated with said touch screen event based on said active event zone and an event mode associated with said active event zone.

21. The touch screen control module of claim 20, wherein said event identifier includes an event position identifier that identifies a position of said touch screen event and based thereon designates said active event zones.

22. The touch screen control module of claim 20, wherein said event identifier includes an event type identifier that identifies an event type of said touch screen event, said application interface outputting said application formatted data set based on said event type.

23. The touch screen control module of claim 20, further comprising a zone mode table storing said zone mode records.

24. The touch screen control module of claim 20, further comprising a zone position table storing records identifying positions of each of said event zones.

25. The touch screen control module of claim 20, wherein said touch screen interface receives a series of touch and release events and based thereon said application interface outputs a command corresponding to at least one of a single left button mouse click, a double left button mouse click, a right button mouse click, an ASCII character, an ASCII character string, a keyboard function, a calculator functions, a signature, a series of coordinates, and a system functional command.
